(19) United States
(12) Patent Application Publication
(10) Pub. No.: US 2011/0310470 A1
(43) Pub. Date: Dec. 22, 2011

(54) DISPLAY DEVICE

(75) Inventor: Wataru Horie, Osaka (JP)

(73) Assignee: Sharp Kabushiki Kaisha, Osaka-shi, Osaka (JP)

(21) Appl. No.: 13/138,492

(22) PCT Filed: Nov. 18, 2009
(86) PCT No.: PCT/JP2009/069548

§ 371 Date: Aug. 26, 2011

(30) Foreign Application Priority Data
Mar. 25, 2009 (JP) 2009074034

(51) Int. Cl. G02B 5/30; G02B 5/20

(52) U.S. Cl. 359/352

(57) ABSTRACT

At least one embodiment of the present invention provides a display device that is capable of suppressing reflection and temperature increases in a display panel so that a favorable display characteristic is obtained even during outdoor use, and that can be realized by a simple configuration. In at least one example embodiment, the present invention is a display device including: a display panel; and a protective plate disposed further toward a viewing surface side than the display panel, wherein a low reflection film formed with a nanostructure is provided on a main surface of the protective plate on the viewing surface side, and a circularly polarizing plate and an infrared ray shielding film are disposed in sequence from the protective plate side toward the display panel side on a main surface of the protective plate on a side for disposing the display panel.

### TECHNICAL FIELD

The present invention relates to a display device, and more particularly to a display device that includes a protective plate for protecting a display panel and can therefore be used suitably as digital signage.

### BACKGROUND ART

An advertising medium referred to as digital signage is known as one utilization form of a liquid crystal display device, and demand for digital signage is increasing. Digital signage is often used outdoors, and therefore a protective plate for protecting a liquid crystal panel employed as a display panel from external impacts, dust, and so on is disposed on a display surface side.

When a liquid crystal display device having the configuration described above is used in sunlight, the sunlight may be reflected by a surface of the protective plate, making an image display difficult to see. Further, when a temperature of the liquid crystal panel increases such that the temperature of the liquid crystal exceeds a phase transition point, an alignment of the liquid crystal may vary, causing a display defect. It is therefore desirable to reduce reflected light on the surface of the display device and suppress increases in the temperature of the liquid crystal panel.

Providing an antireflection film having a multi-layer structure on a front surface of the protective plate has been proposed as means for reducing reflected light (see Patent Document 1, for example). Further, providing a film or the like capable of suppressing temperature increases and heat deterioration caused by solar radiation on the liquid crystal panel has been proposed as means for suppressing increases in the temperature of the liquid crystal panel (see Patent Document 2, for example).

Furthermore, Patent Document 3 proposes an optical filter in which an antireflection film is provided on the display surface side of the protective plate to reduce reflected light and a film that reflects near infrared rays is provided to prevent malfunctioning of a remote controller. Increases in the temperature of the liquid crystal panel are caused mainly by infrared rays contained in sunlight, and it may therefore be assumed that by providing the protective plate with the optical filter described above, a reduction in reflected light and suppression of temperature increases in the liquid crystal panel can both be realized.

Patent Document 1: Japanese Patent Application Publication No. H11-258592

Patent Document 2: Japanese Patent Application Publication No. 2008-163139

Patent Document 3: Japanese Patent Application Publication No. H9-325211

### SUMMARY OF THE INVENTION

### Problems to be Solved by the Invention

However, the antireflection film described in Patent Document 1 is only capable of suppressing reflectance in relation to light having a certain specific wavelength, and as a result, blue and red tints may appear in the reflected light, thereby affecting a display characteristic of the display device.

Further, the film described in Patent Document 2, although capable of suppressing temperature increases in the liquid crystal panel, is configured such that oxides of Bi (bismuth), Y (yttrium), and so on are contained in a transparent resin component thereof. Hence, a refractive index of the film with respect to visible light is high, and therefore, when the film is used in sunlight, visible light may be reflected, making the image display difficult to see. Note that a visible light reflectance of a glass substrate provided with this type of film (heat reflecting glass, product name SUNCUT Σ, manufactured by Asahi Glass Co., Ltd.) takes a high value between approximately 7.0 and 32.2%.

Further, in the optical filter described in Patent Document 3, to form a film for reflecting near infrared rays, a film having a multi-layer structure including nineteen layers must be formed in a vacuum process while maintaining a highly precise film thickness. Therefore, when this optical filter is applied as the protective plate described above, increases occur not only in manufacturing complexity but also in manufacturing cost. Moreover, when a display device is used as digital signage, a large display panel is employed, but when the multi-layer film described above is formed on a large substrate, infiltration by foreign particles, cracks, and so on are more likely to occur, making mass production difficult.

The present invention has been designed in consideration of these circumstances, and an object thereof is to provide a display device that is capable of suppressing reflection and temperature increases in a display panel so that a favorable display characteristic is obtained even during outdoor use, and that can be realized by a simple configuration.

### Means for Solving the Problem

In the course of various investigations into means for improving a display characteristic of a display device, the present inventors found that when the display device is used outdoors, visible light and infrared rays contained in sunlight affect the display characteristic. Accordingly, the present inventors discovered that (1) by providing a low reflection film formed with a nanostructure on a viewing surface side of a protective plate disposed on a front surface of a display panel, surface reflection of visible light can be suppressed, and (2) by disposing a combination of an infrared ray shielding film and a circularly polarizing plate on the display panel side of the protective plate, infrared rays can be blocked while suppressing internal reflection of visible light. Using methods (1) and (2), the present inventors were able to realize a display device having a simple configuration and exhibiting a favorable display characteristic, and were thus able to solve the problems described above and arrive at the present invention.

More specifically, the present invention is a display device including: a display panel and a protective plate disposed further toward a viewing surface side than the display panel, wherein a low reflection film (an antireflection film) formed with a nanostructure is provided on a main surface of the protective plate on the viewing surface side, and a circularly polarizing plate and an infrared ray shielding film are disposed in sequence from the protective plate side toward the display panel side on a main surface of the protective plate on a side for disposing the display panel.

A liquid crystal panel, an organic electroluminescence (EL) panel, a plasma display panel (PDP), a field emission display (FED) panel, and so on may be cited as examples of the display panel. For example, when a liquid crystal panel is used, a large display panel can be realized easily and inexpensively as digital signage for outdoor use.

The protective plate is a substrate for protecting the display panel from dust and impacts. The protective plate is typically formed from a transparent member, and a resin plate made of acrylic resin, polycarbonate resin, or the like, a glass substrate, and so on, for example, may be employed. Further, the protective plate may be colorless or colored. When the protective plate is colorless, the display device can display an image in tones corresponding to the tones displayed on the display panel, and when the protective plate is colored, the display device can display the image displayed on the display panel as an image modified to a blue tone, a red tone, and so on, for example. Furthermore, there are no particular limitations on the thickness of the protective plate.

There are no particular limitations on the low reflection film as long as a nanostructure is formed on the front surface thereof, but a member obtained by forming a nanostructure on the front surface of a transparent resin film such as an acrylic-based resin film is preferably used. The nanostructure formed on the front surface is a surface structure on which a plurality of projections having an average height of no less than 1 nm and no more than 1 μm (=1000 nm) are formed. There are no particular limitations on the shape of the projections, and projections of various shapes, such as a conical shape, a pyramidal shape, a columnar shape, or a rectangular column shape, maybe applied. Examples of methods for forming the nanostructure include a formation method employing nanoimprinting and a formation method of depositing a resin through which nanoparticles, filler, or the like are dispersed. A reflectance of the low reflection film is preferably no more than 0.9%.

In the present invention, a low reflection film having a moth eye structure as the nanostructure can be applied favorably. A structure formed with a plurality of conical projections having an average height of no less than 10 nm and no more than 500 nm, and a pitch interval between adjacent projections is no less than 30 nm and no more than 600 nm can be applied favorably as the moth eye structure. A period of the pitch between adjacent projections may be regular or irregular. A film (sheet) having a moth eye structure on its front surface can be realized by forming the moth eye structure on the front surface of a film formed from light curing acrylic-based resin or the like, for example. In this case, assuming that a refractive index of a film serving as a base material for the low reflection film is 1.5, when the moth eye structure is not formed, an interface reflectance of visible light on an interface between air (refractive index=1.0) and the base material film (refractive index=1.5) is 4.0%, but when the moth eye structure is formed on the interface, the visible light reflectance can be reduced to approximately 0.2%. The reason for this is believed to be that since the projections of the nanostructure are considerably smaller than a length (380 to 780 nm) of a wavelength of visible light, a refractive index between tip ends of the projections of the nanostructure and the base film under the projections appears to vary continuously between 1.0 and 1.5 from the viewpoint of visible light.

The circularly polarizing plate is typically constituted by a linear polarizer and a λ/4 phase difference plate. The λ/4 phase difference plate is a birefringent body having a thickness direction phase difference (95 to 195 nm) of ¼ of the length of the wavelength of visible light, and preferably a birefringent body having a thickness direction phase difference between 120 and 150 nm. By attaching the circularly polarizing plate to the protective plate, external light entering the display device can be prevented from leaking out to the exterior of the display device even when reflected inside the display device. With the circularly polarizing plate, therefore, internal reflection in the display device can be reduced. In the present invention, the circularly polarizing plate is preferably constituted by a linear polarizer provided with a protective layer and a λ/4 phase difference plate, and attached to the protective plate via the protective layer. The reason for this is that the linear polarizer is typically vulnerable to humidity, weak in terms of mechanical strength, and so on. Further, during outdoor use, the display device may be exposed to rain, and condensation may form thereon. Hence, the circularly polarizing plate must be disposed on the display panel side rather than the protective plate viewing surface side to be protected from water.

In an example of a configuration used as the linear polarizer provided with the protective layer, a PVA (polyvinyl alcohol)-based film to which an iodine complex or a dichroic pigment has been adsorbed is used as the linear polarizer, and the linear polarizer is sandwiched between protective layers formed from a cellulose-based polymer such as triacetyl cellulose (TAC). Note that the protective layer may be provided on both surfaces of the linear polarizer or only on the protective plate side surface. To suppress deterioration of the PVA, the protective layer is preferably capable of absorbing ultraviolet rays. Accordingly, the protective layer is preferably formed such that ultraviolet rays having a shorter wavelength than 370 nm that enter the protective layer can be reduced to no more than 1.0%.

Note that in the present invention, the circularly polarizing plate may be used as a polarizer disposed on the viewing surface side of the liquid crystal panel. In so doing, the need to provide another polarizer on the viewing surface side of the liquid crystal panel is eliminated, and therefore, in comparison with a case where a polarizer for reducing internal reflection and a polarizer for black display are provided separately, the number of polarizers used in the entire device can be reduced by one, leading to a reduction in cost.

The infrared ray shielding film may be either an infrared ray absorbing film that absorbs infrared rays or an infrared ray reflecting film that reflects infrared rays. The infrared ray shielding film preferably exhibits an infrared ray shielding rate of at least 10%. Infrared rays include near infrared rays, middle infrared rays, and far infrared rays, but the rays that cause the temperature of the display panel to rise are mainly near infrared rays (750 to 2500 nm). Therefore, in the present invention, the infrared ray shielding film is preferably a film that can absorb or reflect mainly near infrared rays, and particularly preferably a film having a near infrared ray shielding rate of at least 10%. Further, the infrared ray shielding film is disposed on the display surface side of the display panel and is therefore preferably transparent.

The infrared ray shielding film preferably contains a metal oxide. In metal oxides, a plasma frequency exists in the vicinity of a boundary (800 to 1000 nm) between a visible light region and a near infrared region, and therefore metal oxides often exhibit a superior infrared ray shielding effect. Note, however, that electrical conductivity is not necessarily required to realize an infrared ray shielding effect.

Specific examples of metal oxides include ITO (Indium Tin Oxide), ATO (Antimony Tin Oxide; tin oxide doped with antimony), ZTO (Zinc Tin Oxide), antimony oxide, and zinc oxide. Of these metal oxides, ATO and antimony oxide are preferable since they are available in micro-particle form and can therefore be charged into a resin to form a thin film easily.

The metal oxide particles preferably have an average particle diameter of less than 100 nm. The reason for this is that when the average particle diameter of the particles exceeds 100 nm, visible light scattering occurs, causing cloudiness in a display image.

The infrared ray shielding film formed by the metal oxide typically has an extremely high refractive index of approximately 2.0, and therefore exhibits high visible light reflectance. In the present invention, however, the infrared ray shielding film is combined with the circularly polarizing plate described above, and therefore infrared rays can be blocked while suppressing visible light reflection. The reason for this will be described below.

In the display device according to the present invention, the low reflection film, the protective plate, the circularly polarizing plate, and the infrared ray shielding film are disposed in that order from the viewing surface side. More specifically, the low reflection film is used to reduce light reflection on the front surface of the protective plate and is therefore provided on the viewing surface side of the protective plate. As noted above, the infrared ray shielding film exhibits high visible light reflectance and is therefore disposed further toward the display panel side than the low reflection film. However, infrared rays are likely to cause temperature of the infrared ray shielding film increases, and therefore the infrared ray shielding film is provided on the protective plate side rather than directly on the display panel. As noted above, the infrared ray shielding film exhibits high reflectance, and therefore the circularly polarizing plate must be disposed on the viewing surface side in order to suppress visible light reflection. To improve water resistance, the circularly polarizing plate is disposed on the display panel side of the protective plate, and therefore the infrared ray shielding film is also disposed on the display panel side of the protective plate. As a result, the low reflection film is disposed on the viewing surface side of the protective plate, while the circularly polarizing plate and the infrared ray shielding film are disposed on the display panel side in that order.

The configuration of the display device of the present invention is not especially limited as long as it essentially includes such components.

The display device according to the present invention, configured as described above, has a simple configuration whereby the low reflection film, the protective plate, the circularly polarizing plate, and the infrared ray shielding film are disposed in that order, and is capable of suppressing light reflection and temperature increases in the display panel so that a superior display characteristic can be realized.

In the display device according to the present invention, light reflection occurs on the front surface of the protective plate on the viewing surface side (the low reflection film), the infrared ray shielding film, and the front surface of the display panel. In other words, when the display device is irradiated with sunlight, light that is reflected on the front surface of the protective plate (the low reflection film) and light that is transmitted through the protective plate are generated. In the present invention, the low reflection film is provided on the viewing surface side of the protective plate as described above, and therefore unnecessary reflected light is suppressed. As a result, a display device exhibiting favorable image display is obtained.

Of the light that passes through the protective plate, the visible light is converted into linearly polarized light by the linear polarizer and then converted into circularly polarized light after passing through the λ/4 phase difference plate. A part of the visible light that passes through the λ/4 phase difference plate is reflected by the front surface of the infrared ray shielding film, while the remainder passes through the infrared ray shielding film and then either passes through the display panel or is reflected on the front surface or in the interior of the display panel. The visible light reflected on the front surface of the infrared ray shielding film or on the front surface or in the interior of the display panel forms reversed circularly polarized light. This light re-enters the λ/4 phase difference plate to be converted into linearly polarized light, and is then absorbed substantially entirely by the linear polarizer. Meanwhile, the infrared rays (near infrared rays having a wavelength between 750 and 2500 nm and so on) included in the light that passes through the λ/4 phase difference plate is absorbed or reflected by the infrared ray shielding film.

Hence, almost all of the light (infrared rays) entering the protective plate from the viewing surface side can be absorbed. When reflection on the front surface or in the interior of the display panel is sufficiently reduced, a reflected light suppression effect generated by the low reflection film can be reflected sufficiently in an improvement in a display quality of the display device.

Further, to suppress a temperature increase in the display panel in sunlight, measures must be taken to ensure that the display panel does not absorb visible light and infrared rays. In the present invention, almost all visible light entering the protective plate can be absorbed by the circularly polarizing plate as described above, while infrared rays can be prevented from reaching the display panel by the infrared ray shielding film. As a result, temperature increases in the display panel can be suppressed.

Note that when the display panel is a liquid crystal panel, for example, a temperature increase is generated in the display panel by a polarizer and a black matrix of a color filter layer in the liquid crystal panel. The liquid crystal panel is typically constituted by sandwiching liquid crystal between a color filter substrate for performing color display and an opposed substrate, and providing polarizers on respective front surfaces of the two substrates.

The color filter substrate is formed by providing color filter layers in R (red), G (green), and B (blue), for example, on a transparent glass substrate, and the respective color filter layers are defined by a black colored layer known as a black matrix. The black matrix is black and therefore absorbs sunlight so as to generate heat easily. Further, a transparent electrode is disposed further toward the liquid crystal layer side than the color filter layers, and this transparent electrode also absorbs sunlight so as to generate heat.

When the temperature of the liquid crystal panel is raised by the heat generated in this manner described above such that the temperature of the liquid crystal exceeds a transition temperature, a display defect occurs.

Heat is also generated when a display panel other than a liquid crystal panel is used. For example, when the display panel is an organic EL panel, sunlight is absorbed by a transparent electrode and an emissive layer, and when the display panel is a PDP, sunlight is absorbed by a fluorescent material and a black layer.

Moreover, a display panel for outdoor use is typically accommodated in a housing. Drivers, wiring, and so on are accommodated in the housing together with the display panel, and to make these components difficult to see from the outside, thereby improving the design of the device, the housing is colored. When the housing is colored, the housing absorbs sunlight in a similar manner to that described above, and as a result, heat is generated.

When heat is generated in the manner described above such that the temperature of the display panel increases, an emission efficiency deteriorates in the case of an organic EL display or a PDP, and as a result, the reliability of the device may be adversely affected over the long term.

In the display device according to the present invention, as a preferred aspect for suppressing temperature increases in the display panel, the display panel includes a light shielding member in a non-display region, and the infrared ray shielding film is formed in a region corresponding to the light shielding member. The light shielding member in the non-display region is the aforethe black matrix, for example. By providing the infrared ray shielding film in accordance with a member that absorbs sunlight (infrared rays) easily in this manner, temperature increases in the display panel can be reduced more reliably. This type of infrared ray shielding film can be realized by mixing ATO micro-particles into a resin material exhibiting ultraviolet (UV) photosensitivity and forming a pattern.

Depending on the material used to form the infrared ray shielding film, visible light may be absorbed, but even in this case, the infrared ray shielding film is provided only in the non-display region, and therefore the infrared ray shielding film can be formed from a material exhibiting a great infrared ray shielding effect without taking into consideration a visible light transmittance. Moreover, the visible light transmittance in the display region is not reduced, and therefore image display can be performed favorably.

In the display device according to the present invention, as another preferred aspect for suppressing temperature increases in the display panel, the protective plate and the display panel are thermally separated. In the present invention, thermal separation specifically means forming a vacuum layer or a gas layer between a main surface of the protective plate and a main surface of the display panel. In so doing, movement of heat generated in the infrared ray shielding film to the display panel can be suppressed. A vacuum layer is more preferable since temperature increases in the display panel due to gas convection can also be suppressed thereby.

In a preferred aspect of the display device according to the present invention, the protective plate further includes a base layer on which a phase difference in a plane direction and a thickness direction is substantially zero (optically isotropic), and the base layer is disposed further toward the display panel side than the infrared ray shielding film. Thus, the separately manufactured infrared ray shielding film and circularly polarizing plate can be adhered to each other easily without damaging the effect of the circularly polarizing plate, and as a result, a reduction in manufacturing cost can be achieved.

Further, the display device may further include a support substrate provided on an opposite side to a side of the display panel on which the protective plate is disposed. By employing a support substrate in this manner, a back surface side of the display panel can be protected.

The display device may further include an additional low reflection film formed with a nanostructure between the display panel and the support substrate. With this configuration, reflection of light from a light source provided on the back surface side of the display panel can be reduced.

Further, the display device may further include a light source provided on the opposite side to the side of the display panel on which the protective plate is disposed. When the display panel is a liquid crystal panel, a transmission type liquid crystal display device and a transflective liquid crystal display device may be cited as examples of a display device thus configured.

In the display device according to the present invention, the display panel and the support substrate may contact each other. With this configuration, an air interface between the display panel and the support substrate can be reduced, and therefore light from the light source can be taken in efficiently in a case where the light source is provided on the support substrate side. Note, however, that in order to suppress temperature increases in the display panel, the protective plate and the support substrate are preferably insulated from each other.

The support substrate may be a light guide plate. A light guide plate is a plate-shaped member formed with a pattern for reflecting, refracting, or diffusing light, and an optical member including a reflection portion that reflects light entering from the light source such that the light is emitted/dispersed in a surface shape onto the display surface side. There are no particular limitations on the shape, material, and so on of the light guide plate, but the light guide plate is typically formed from a colorless, transparent, plate-shaped material having a constant thickness.

Digital signage may be cited as a favorable application of the display device according to the present invention. As noted above, digital signage is an advertising medium used outdoors or the like. With the display device according to the present invention, light reflection on the front surface of the protective plate can be suppressed even during exposure to sunlight, and temperature increases in the display panel can be suppressed. Therefore, digital signage exhibiting a favorable display characteristic can be realized. Further, a cooling device conventionally required to cool the display panel is no longer required, and therefore a reduction in cost can be achieved.

In an example of the display device according to the present invention, the display panel is accommodated in the housing, and the display panel and housing are covered by the protective plate. A backlight serving as the light source, a driver for driving the display panel, and so on are typically accommodated in the housing together with the display panel. There are no particular limitations on the shape, material, strength, and so on of the housing, and these elements may be set in accordance with the shape, usage application, and so on of the display panel.

Note that in the display device according to the present invention, configurations of the respective members and films provided on the protective plate may be verified by measuring the transmittance and reflectance thereof.

### Effects of the Invention

According to the present invention, a display device that is capable of suppressing reflection and temperature increases in a display panel so that a favorable display characteristic is obtained even during outdoor use can be realized by a simple configuration.

### BRIEF DESCRIPTION OF THE DRAWINGS

FIG. 1(a) is a sectional pattern diagram showing the configuration of a display device according to Embodiment 1 of the present invention, FIG. 1(b) is a plan view illustrating an attachment state of a liquid crystal panel, and FIG. 1(c) is a sectional view taken along an A-B line in FIG. 1(b);

FIG. 2 is a view showing a radiation wavelength distribution of a light source during a solar radiation irradiation test performed on display panels according to Example 1 and Comparative Example 1;

FIG. 3 is a graph showing results obtained by measuring characteristics of an infrared ray shielding film according to Example 2 of the present invention;

FIG. 4 is a sectional pattern diagram showing the configuration of a display device according to Embodiment 2 of the present invention;

FIGS. 5(a) to 5(c) are sectional pattern diagrams showing the configuration of a display device according to Embodiment 3 of the present invention;

FIG. 6 is a sectional pattern diagram showing the configuration of a display device according to Embodiment 4 of the present invention;

FIG. 7 is a sectional pattern diagram showing the configuration of a display device according to Embodiment 5 of the present invention; and

FIG. 8 is a sectional pattern diagram showing the configuration of a display device according to Embodiment 6 of the present invention.

### EMBODIMENTS FOR CARRYING OUT THE INVENTION

The present invention will be described in further detail below using embodiments. However, the present invention is not limited to these embodiments alone. Note that in the drawings used throughout the following description, identical configurations have been allocated identical reference numerals, and duplicate description thereof has been omitted.

### Embodiment 1

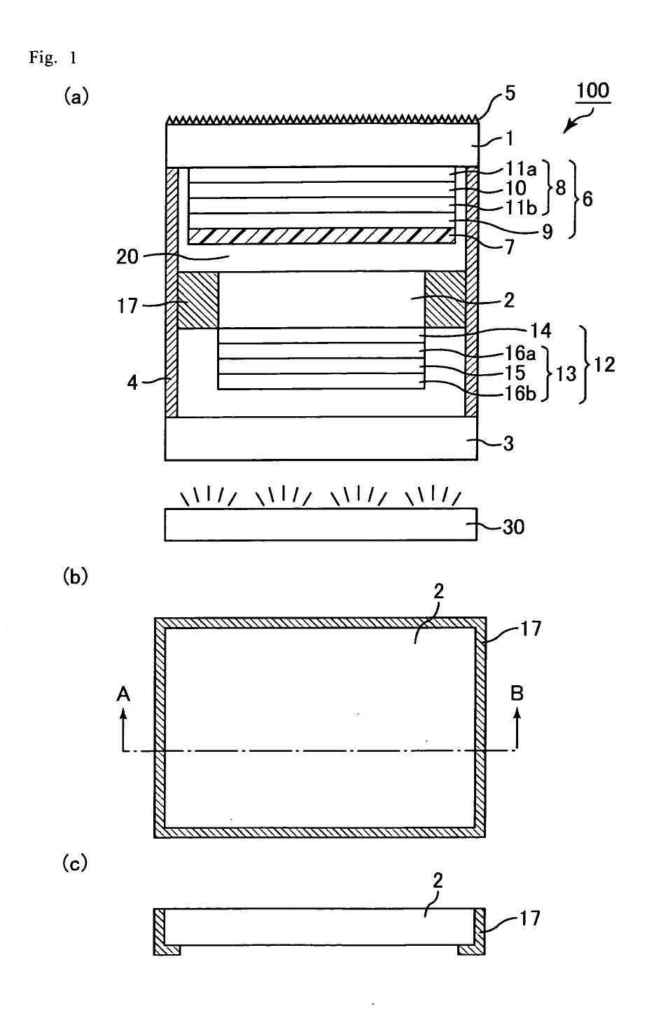

FIG. 1(a) is a sectional pattern diagram showing the configuration of a display device according to Embodiment 1 of the present invention. FIG. 1(b) is a plan view illustrating an attachment state of a liquid crystal panel. FIG. 1(c) is a sectional view taken along an A-B line in FIG. 1(b). The display device according to this embodiment may be applied to any of a transmission type device, a reflection type device, or a transflective device, but in the following description, a transmission type display device will be cited as an example.

In FIG. 1(a), a display device 100 includes a protective plate 1, a liquid crystal panel 2, and a support substrate 3, wherein the liquid crystal panel 2 is held in a housing 4 via a support 17. Further, a backlight 30 is provided on a back surface side of the support substrate 3.

As shown in FIGS. 1(b) and 1(c), the liquid crystal panel 2 is held by the support 17, which is formed to be slightly larger than an outer form of the liquid crystal panel 2. The support 7 is preferably formed from a heat insulating material. The liquid crystal panel 2 held by the support 17 is fixed to the housing 4 by a screw.

The protective plate 1 is formed from a transparent member, and an antireflection film 5 having a moth eye structure on a front surface thereof is formed on a viewing surface side main surface of the protective plate 1.

A circularly polarizing plate 6 and an infrared ray shielding film 7 are laminated in that order onto a liquid crystal panel 2 side main surface of the protective plate 1. The circularly polarizing plate 6 is constituted by a polarizer 8 and an λ/4 phase difference plate 9, wherein the polarizer 8 is constituted by a linear polarizer 10 and protective layers 11a, 11b disposed on either surface thereof.

The infrared ray shielding film 7 is formed to have an identical pattern to a formation pattern of a black matrix provided on a color filter substrate of the liquid crystal panel 2.

The liquid crystal panel 2 may be an active matrix type panel or a passive matrix type panel, but here, the liquid crystal panel 2 will be described using an active matrix type panel as an example. The liquid crystal panel 2 is formed by sandwiching liquid crystal between the color filter substrate and a TFT substrate and then aligning the liquid crystal. The color filter substrate is formed by providing color filter layers in respective colors R (red), G (green), and B (blue) and a black matrix defining the color filter layers on a main surface of a glass substrate, and the TFT substrate is formed by providing switching TFT elements corresponding to respective pixels on a main surface of a glass substrate.

A circularly polarizing plate 12 is provided on the support substrate 3 side of the liquid crystal panel 2, and the circularly polarizing plate 12 is constituted by a polarizer 13 and an λ/4 phase difference plate 14. The polarizer 13 is constituted by a linear polarizer 15 and protective layers 16a, 16b disposed on either surface thereof. Note that a circularly polarizing plate is not provided on the viewing surface side main surface of the liquid crystal panel 2, but the circularly polarizing plate 6 attached to the protective plate 1 serves as a polarizer that corresponds to the circularly polarizing plate 12, while the polarizer 8 and the polarizer 13 are disposed such that respective absorption axes thereof are orthogonal to each other.

The support substrate 3 is a transparent member, and a resin plate made of acrylic resin, COP (cyclo-olefin polymer) resin, or the like, a glass substrate, and so on, for example, may be used as the support substrate 3.

The housing 4 accommodates the liquid crystal panel 2, and the liquid crystal panel 2 is attached to the housing 4 while held by the support 17 as described above. As well as the display panel, a driver for driving the display panel and so on, not shown in the drawings, are also accommodated in the housing 4.

The protective plate 1 is disposed to cover the liquid crystal panel 2 held in the housing 4, but the protective plate 1 is insulated from the liquid crystal panel 2 by the housing 4. Further, an air layer 20 is formed between the protective plate 1 and the liquid crystal panel 2 so that the protective plate 1 and the liquid crystal panel 2 are thermally separated from each other more reliably.

Light reflection and the like occurring when the display device 100 configured as described above is used outdoors will now be described. When the display device 100 is irradiated with sunlight, light that is reflected and light that enters the protective plate 1 are generated on the front surface of the protective plate 1. As regards visible light that would be reflected by the front surface of the protective plate 1 under normal circumstances, reflection of this visible light is suppressed by the antireflection film 5, and therefore reflection is suppressed such that a favorable display characteristic is obtained.

Meanwhile, visible light that enters the protective plate 1 is converted into linearly polarized light by the polarizer 8 and then converted into circularly polarized light after passing through the λ/4 phase difference plate 9. A part of the visible light and infrared rays in a display region passes through the air layer 20 and then are reflected by the front surface of the liquid crystal panel 2, but resulting reflected light re-enters the circularly polarizing plate 6 in a state where a rotation direction of the circularly polarized light is reversed, and therefore almost all of the light is absorbed by the circularly polarizing plate 6. Note that the visible light in the display region passes through the air layer 20 without passing through the infrared ray shielding film 7, and therefore a visible light transmittance in the display region does not decrease.

Further, of the light that passes through the λ/4 phase difference plate 9, infrared rays in a non-display region are absorbed or reflected by the infrared ray shielding film 7. Light other than infrared rays, in particular visible light, may either be reflected by or pass through a front surface of the infrared ray shielding film 7. The light that is reflected by the front surface of the infrared ray shielding film 7 re-enters the circularly polarizing plate 6 in a state where the light rotation direction is reversed, while the light that passes through the infrared ray shielding film 7 passes through the air layer 20 and then enters the circularly polarizing plate 6 in a similar manner to that described above. Hence, almost all of the light is absorbed by the circularly polarizing plate 6.

Therefore, with the display device 100 according to this embodiment, reflection can be suppressed and a favorable display characteristic can be obtained even during outdoor use.

The temperature of the liquid crystal panel 2 is increased by the black matrix and the polarizers constituting the liquid crystal panel 2, but in Embodiment 1, the infrared ray shielding film 7 is provided in a position corresponding to the black matrix, and therefore the light that reaches the liquid crystal panel 2 is light from which infrared rays have been removed. Hence, increases in the temperature of the liquid crystal panel 2 can be suppressed. Further, the circularly polarizing plate 6 serving as a polarizer is attached to the protective plate 1 rather than the liquid crystal panel 2 and does not therefore cause the temperature of the liquid crystal panel 2 to rise. Moreover, even if the temperature of the protective plate 1 rises, the protective plate 1 and the liquid crystal panel 2 are thermally separated from each other, and therefore heat from the protective plate 1 is not easily transferred to the liquid crystal panel 2. Hence, increases in the temperature of the liquid crystal panel 2 can be further suppressed. As a result, variation in the liquid crystal alignment caused by an increase in the temperature of the liquid crystal panel 2 can be suppressed, and therefore a favorable display characteristic can be realized in the liquid crystal panel 2.

An example of a manufacturing method for the display device 100 according to this embodiment will now be described. First, the polarizer 8 is prepared by laminating the protective layers 11a, 11b onto either surface of the linear polarizer 10 and a film is prepared by adhering the infrared ray shielding film 7 to the λ/4 phase difference plate 9. The linear polarizer 8 and the film are then adhered to each other via an adhesive layer in a state where the absorption axis of the linear polarizer 10 and a slow axis of the λ/4 phase difference plate 9 have a difference in direction of axes by 45°. A resulting laminated film is adhered to the main surface of the protective plate 1 via an adhesive layer. Next, the antireflection film 5 is adhered to the other main surface of the protective plate 1 via an adhesive layer.

Next, the λ/4 phase difference plate 11 and the circularly polarizing plate 12 are adhered via an adhesive layer to the side of the liquid crystal panel 2, which is constituted by the color filter substrate and the TFT substrate, on which the TFT substrate is disposed.

The liquid crystal panel 2 having the above configuration is then disposed between the protective plate 1 having the above configuration and the support substrate 3 and held in the housing 4. The housing 4 is formed such that the liquid crystal panel 2 is fixed and outside air does not infiltrate the interior of the housing 4, and a part for fixing the liquid crystal panel 2 is made of an insulating material such as rubber. Note that a mechanism for circulating cooled air may be provided in the housing 4 to suppress increases in the temperature of the liquid crystal panel 2.

The backlight 30 serving as a light source is then provided on the back surface side of the support substrate 3, whereby the display device 100 is obtained.

Effects obtained when temperature increases in the liquid crystal panel 2 are suppressed and reflection on the protective plate 1 is prevented in the display device 100 according to Embodiment 1 will now be described using examples, comparative examples, and reference examples.

### EXAMPLE 1

(Configuration of Display Panel)

In the display device 100 shown in FIG. 1(a), an acrylic resin plate having a refractive index of 1.5 and a thickness of 3.0 mm was used as the protective plate 1. A film formed from light curing acrylic resin and having a moth eye structure on a front surface thereof was used as the antireflection film 5. The moth eye structure was created by forming a plurality of conical projections having an average height of approximately 200 nm and setting a pitch interval between adjacent projections at no more than approximately 200 nm.

A 16-inch active matrix type liquid crystal panel was used as the liquid crystal panel 2, and a panel in which a phase transition occurs in an isotropic phase when the temperature of the liquid crystal layer reaches 80° C. was selected.

An acrylic-based resin film containing ATO particles having an average particle diameter of 30 nm was used as the infrared ray shielding film 7. A transparent acrylic resin plate having a refractive index of 1.5 and a thickness of 3.0 mm was used as the support substrate 3.

(Solar Radiation Irradiation Test)

A solar radiation irradiation test was performed by disposing an artificial sky illumination device (manufactured by SERIC Ltd., model number XC-100AF) serving as a light source at a remove of 10 cm from a substrate surface of the liquid crystal panel 2 according to Example 1 on the viewing surface side of the protective plate 1.

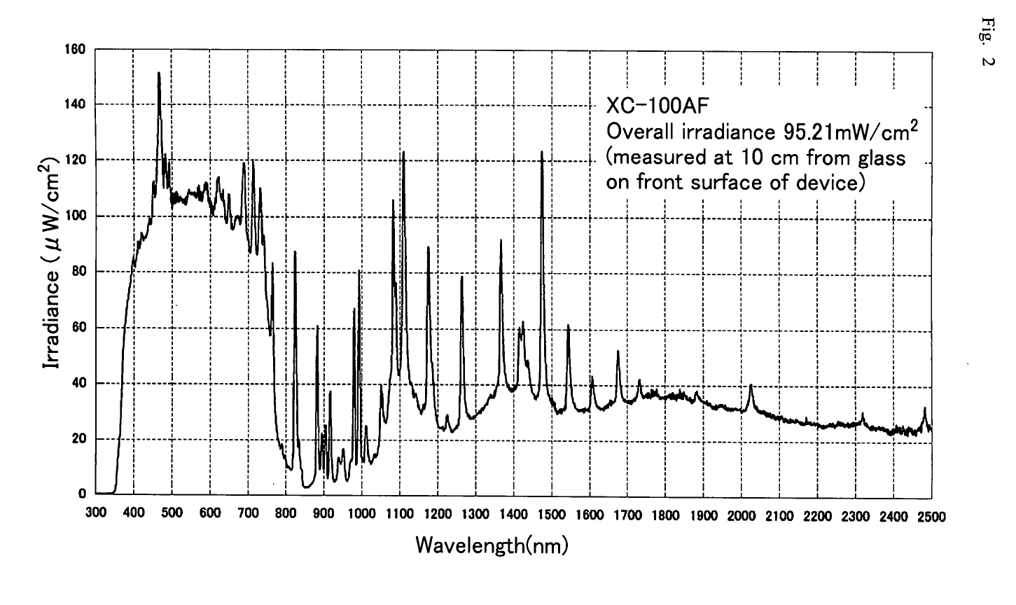

Before emitting light from the light source, a surface temperature on a display surface side of the liquid crystal panel 2 was measured using a thermocouple (copper-constantan), whereby the front surface temperature of the liquid crystal panel 2 was 24° C. The liquid crystal panel 2 was then irradiated with light from the light source, and after one hour, the front surface temperature was measured again. This time, the front surface temperature of the liquid crystal panel 2 was 34° C. Note that at a distance of 10 cm, an integrated irradiance was 952 W/m² (wavelength 300 to 2500 nm). FIG. 2 shows a radiation wavelength distribution of the light source.

### COMPARATIVE EXAMPLE 1

Using a similar 16-inch liquid crystal panel to that of Example 1, circularly polarizing plates were disposed on both main surfaces of the liquid crystal panel in a cross nicol arrangement. Further, the antireflection film 5 and the infrared ray shielding film 7 were not disposed on the protective plate, and instead, the protective plate was disposed on the liquid crystal panel, to which the circularly polarizing plates were adhered, via an air layer. Similarly to Example 1, light was emitted from above the protective plate, and a surface temperature on the circularly polarizing plates of the liquid crystal panel was measured before and after the light irradiation. The surface temperature prior to light irradiation was 24° C., and the surface temperature following one hour of light irradiation was 39° C.

A temperature increase in the liquid crystal panel under an actual solar irradiation condition can be inferred from the measurement results obtained in Example 1 and Comparative Example 1. According to the website of the Japan Meteorological Agency, the solar radiation amount in Osaka during July 2008 was 18.0 MJ/day, for example. This corresponds to 5.3 hours (Hr) of irradiation when the light source of the test described above is used. Therefore, the following results can be inferred from the tests performed in Example 1 and Comparative Example 1.

TABLE 1

| | Temperature | Estimated panel |
|---|---|---|
| | increase rate | temperature |
| Example 1 | 10° C./Hr | 77° C. |
| Comparative | 15° C./Hr | 102.5° C. |
| Example 1 | | |

As shown in Table 1, the liquid crystal panel according to Example 1 does not reach the phase transition temperature of liquid crystal, i.e. 80.0° C., and therefore display defects do not occur. However, the liquid crystal panel according to Comparative Example 1 greatly exceeds the phase transition temperature of liquid crystal, i.e. 80.0° C., and therefore a situation in which display becomes impossible and a screen turns completely black is likely to occur. It may therefore be concluded that with Example 1, a great effect is obtained in terms of suppressing temperature increases in the liquid crystal panel 2, even under actual sunlight.

A wavelength distribution of solar energy reaching the ground has a component ratio over one year of 5.33% light having a wavelength of 300 to 400 nm, 48.48% light having a wavelength of 400 to 700 run, and 46.20% light having a wavelength of 700 to 2500 nm (see Suga Test Instruments Co., Ltd., Technical Report, data for 1997). Assuming that an absorption rate of light in the respective wavelengths is constant, when the liquid crystal panel 2 receives direct sunlight outdoors, it is important to block the light having a wavelength of 700 to 2500 nm. The reason for this is that energy from near infrared rays makes up approximately half of the entire energy of sunlight, and therefore, by blocking the near infrared rays, the increase in the temperature of the liquid crystal panel can be substantially halved.

### EXAMPLE 2

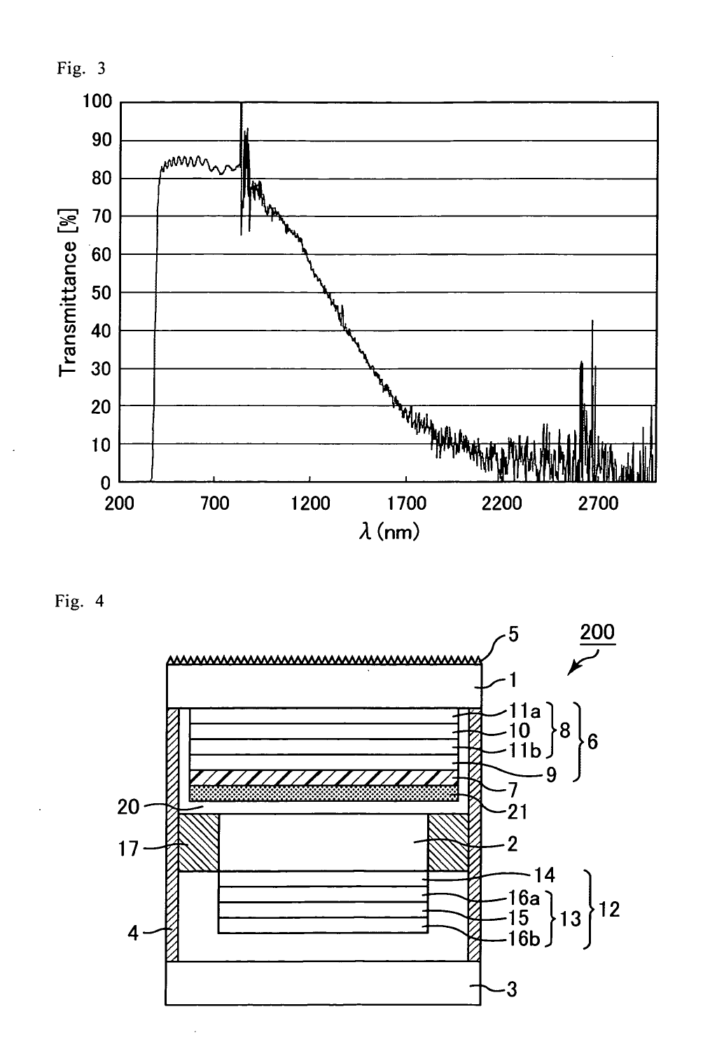

To confirm the characteristics of the infrared ray shielding film 7 used in Example 1, the infrared ray shielding film 7 was adhered to the entire surface of a glass substrate having a thickness of 0.7 mm using an adhesive, whereupon a light transmittance was measured. A C light source was used as the light source, a spectrophotometer (UV3100PC, manufactured by Shimadzu Corporation) was used for the measurement, and the measurement was performed in a 2° viewing field. Obtained measurement results are shown in FIG. 3.

In FIG. 3, the ordinate shows the transmittance (%) of the light passing through the infrared ray shielding film and the abscissa shows the wavelength X. (nm) of the light. As shown in FIG. 3, the infrared ray shielding film 7 had a transmittance of 80% or more in a wavelength region of approximately 780 nm and below, but the transmittance decreased in a wavelength region of approximately 780 nm and above. An infrared ray shielding rate of the infrared ray shielding film 7 was 54%. Hence, in Example 1, near infrared rays (wavelength: approximately 780 to 2500 nm) contained in sunlight were cut by the infrared ray shielding film 7 such that mainly light other than near infrared rays reached the liquid crystal panel, and as a result, temperature increases in the liquid crystal panel were suppressed.

### COMPARATIVE EXAMPLE 2

An identical infrared ray shielding film to that of Example 1 was provided on the viewing surface side circularly polarizing plate of a liquid crystal panel configured similarly to that of Comparative Example 1. An identical protective plate to that of Comparative Example 1 was used. Then, in accordance with a method described in JIS-Z8722, a reflectance on the front surface of the protective plate was measured in a Specular Component Included mode using a spectrophotometer (CM-2002, manufactured by Konica Minolta Sensing Inc.). The obtained reflectance was 12.38%.

### REFERENCE EXAMPLE 1

An identical antireflection film to that of Example 1 was provided on the both main surfaces of the protective plate according to Comparative Example 2. The reflectance on the front surface of the protective plate was then measured in a similar manner to Comparative Example 2. The obtained reflectance was 5.21%, thereby showing a reflectance reduction of 57.9% relative to Comparative Example 2.

### EXAMPLE 3

The front surface reflectance of the protective plate 1 according to Example 1 was measured in a similar manner to Comparative Example 2. The obtained reflectance was 0.30%, thereby showing a reflectance reduction of 97.6% relative to Comparative Example 2.

Comparing Comparative Example 2 with Reference Example 1, it is evident that a greater reflectance reduction effect is obtained with a configuration in which the antireflection film, the circularly polarizing plate, and the infrared ray shielding film are arranged in that order from the viewing surface side of the protective plate 1 than with a configuration in which the antireflection film is provided on both surfaces of the protective plate 1. Further, it can be seen from Comparative Example 2 and Example 3 that a reflectance reduction effect can also be obtained by providing the circularly polarizing plate on the protective plate side rather than the liquid crystal panel side.

### Embodiment 2

FIG. 4 is a sectional pattern diagram showing the configuration of a display device according to Embodiment 2 of the present invention. In FIG. 4, a display device 200 includes, in addition to the configuration of the display device 100 described above, a base layer 21 provided on the liquid crystal panel 2 side main surface of the protective plate 1. The light source 30 is not shown in FIG. 4.

The base layer 21 is provided in a case where the infrared ray shielding film 7 and the circularly polarizing plate 6 are formed separately and then disposed on the protective plate 1. In other words, the base layer 21 is formed in a case where the infrared ray shielding film 7 is formed on the base layer 21 and then the infrared ray shielding film 7 is adhered to the circularly polarizing plate 6 via an adhesive layer (not shown).

As described above, the base layer 21 is sandwiched between the circularly polarizing plate 6 and the circularly polarizing plate 12 to serve as a support member when the infrared ray shielding film 7 is adhered to the protective plate 1. Therefore, to ensure that the effects generated by the circularly polarizing plates 6 and 12 are not impaired, the base layer 21 preferably has small phase differences in a plane direction and a thickness direction. Accordingly, a TAC film used as a protective film for a polarizer may be employed as the base layer 21. The phase difference in the thickness direction is preferably no more than 10 nm, and the phase differences in the plane direction and the thickness direction are preferably substantially zero. A TAC film known as a zero phase difference film may be used as the base layer 21 having these characteristics, and this TAC film also exhibits a protective effect in relation to the circularly polarizing plate 6.

### Embodiment 3

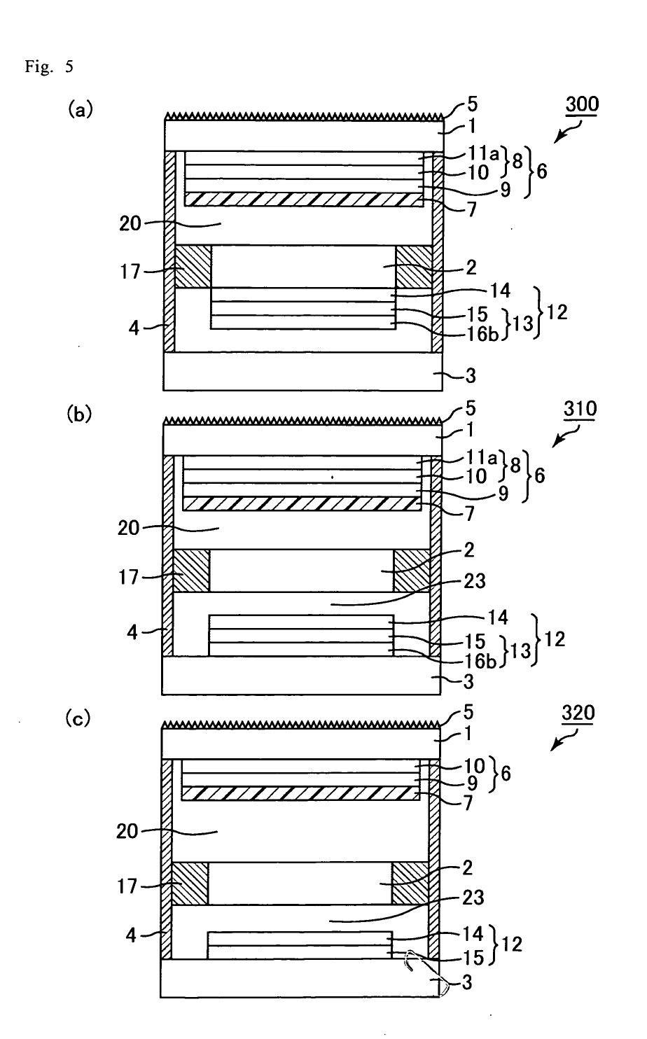

FIGS. 5(a) to 5(c) are sectional pattern diagrams showing the configuration of a display device according to Embodiment 3 of the present invention. In FIG. 5(a), a display device 300 differs from the display device 100 described above in that the protective layers 11b and 16a are removed, but all other configurations are similar to the display device 100. Note that the light source 30 is not shown.

In the display device 300 according to this embodiment, the protective layer lib provided on the protective plate 1 side in the display device 100 according to Embodiment 1 is omitted, and the λ/4 phase difference plate 9 doubles as a protective layer for the linear polarizer 10. Further, the protective layer 16a provided on the liquid crystal panel 2 is omitted, and the λ/4 phase difference plate 14 doubles as a protective layer for the linear polarizer 15.

According to this configuration, the two protective layers for the circularly polarizing plate 6 can be eliminated, enabling a reduction in manufacturing cost and reductions in the size and thickness of the display device 300.

Note that in the above description, one of the protective layers provided on each of the protective plate 1 and the liquid crystal panel 2 is eliminated, but the present invention is not limited thereto, and a protective layer provided on the protective plate 1 or the liquid crystal panel 2, for example, may be removed.

Further, in the display device 300 according to this embodiment, the λ/4 phase difference plate 14, linear polarizer 15, and protective layer 16b provided on the liquid crystal panel 2 may be provided on the support substrate 3 side, as shown in FIG. 5(b). The reason for this is as follows.

As described above, the liquid crystal panel 2 is configured such that the color filter substrate and the TFT substrate oppose each other. However, when a film having a multi-layer structure is formed on only the TFT substrate side, a modulus of elasticity of the glass forming the color filter substrate and the TFT substrate differs from the modulus of elasticity of the resin forming the respective films by at least a single digit, leading to a difference in stress generated on the two main surfaces of the liquid crystal panel 2, and as a result, the liquid crystal panel 2 may warp. Hence, by providing the multi-layer structure film provided on the TFT substrate side on the support substrate 3 side, warping caused by a stress difference can be eliminated.

Therefore, in a display device 310, in which the λ/4 phase difference plate 14, linear polarizer 15, and protective layer 16b are separated from the liquid crystal panel 2, warping does not occur in the liquid crystal panel 2, and as a result, superior display stability can be achieved.

Furthermore, in this embodiment, as shown in FIG. 5(c), the display device 310 provided with the protective layer 11a and the protective layer 16b may be replaced by a display device 320 from which the respective protective plates 11a, 16b are omitted. In the display device 320, the protective plate 1 doubles as a protective layer for the linear polarizer 10 and the support substrate 3 doubles as a protective layer for the linear polarizer 15. Hence, in comparison with the various display devices described above, the number of constitutional members can be minimized, enabling a reduction in manufacturing cost and reductions in the size and thickness of the display device 320.

### Embodiment 4

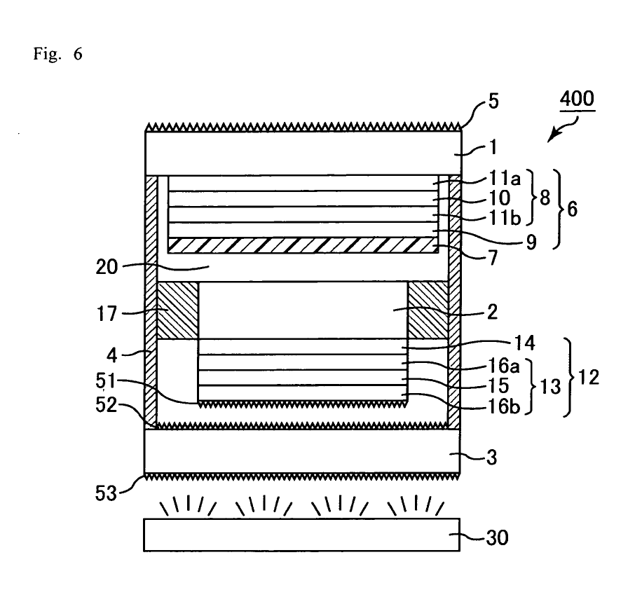

FIG. 6 is a sectional pattern diagram showing the configuration of a display device 400 according to this embodiment. The display device 400 according to this embodiment includes, in addition to the configuration of the display device 100 shown in FIG. 1, antireflection films 51, 52, 53.

By providing the antireflection films 51, 52, 53 on the support substrate 3 side and the liquid crystal panel 2 side, reflection loss in the backlight 30 can be reduced.

Note that in FIG. 6, the antireflection films 51, 52, 53 are provided on the support substrate 3 side and the liquid crystal panel 2 side, but an antireflection film may be provided on only one of the support substrate 3 and the liquid crystal panel 2. Moreover, an antireflection film may be provided on only one main surface of the support substrate 3.

### Embodiment 5

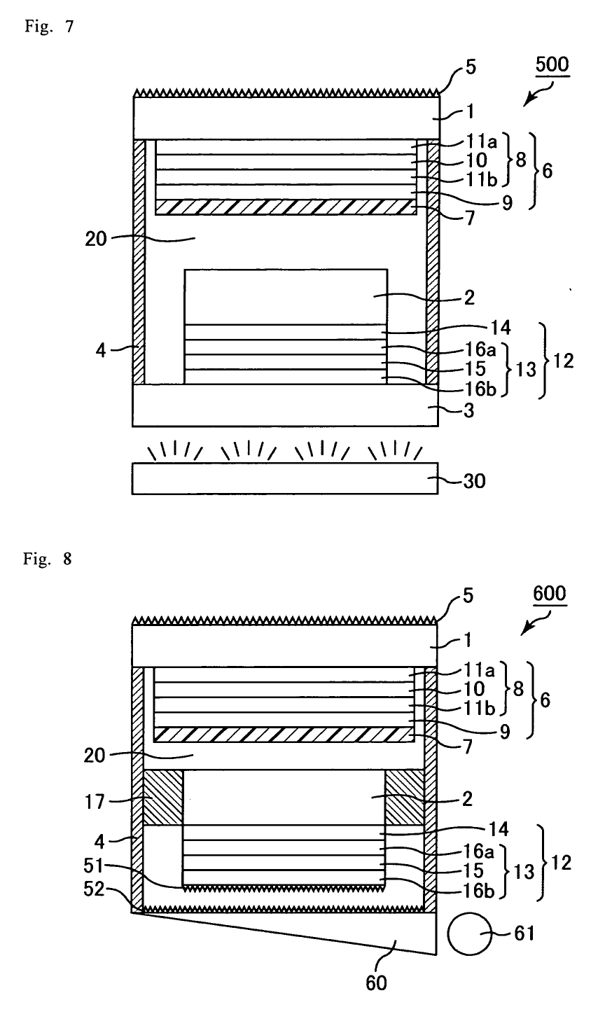

FIG. 7 is a sectional pattern diagram showing the configuration of a display device 500 according to Embodiment 5 of the present invention. The display device 500 according to this embodiment is formed by adhering the liquid crystal panel 2 to the support substrate 3 side in the display device 100 shown in FIG. 1.

According to this configuration, an air interface between the liquid crystal panel 2 and the support substrate 3 can be reduced, enabling a reduction in reflection loss in the backlight 30. Note, however, that when the backlight 30 causes the temperature of the protective plate 1 to rise, the liquid crystal panel 2 and the support substrate 3 are preferably disposed at a remove from each other without being adhered so that heat insulation is realized between the protective plate 1 and the support substrate 3. In so doing, temperature increases in the liquid crystal panel 2 can be suppressed.

### Embodiment 6

FIG. 8 is a sectional pattern diagram showing the configuration of a display device 600 according to Embodiment 6 of the present invention. The display device 600 according to this embodiment is formed by employing a light guide plate 60 as the support substrate 3 and providing a light source 61 on a side portion of the light guide plate 60 in the display device 100 shown in FIG. 1 so that a side light system is realized.

According to this configuration, light from the light source 61 is guided into the display device 600, and as a result, image display can be performed favorably.

Note that in the respective embodiments described above, examples employing the liquid crystal panel 2 as a display panel were described. However, the present invention is not limited thereto and may be applied to various display panels, such as an organic EL panel, a PDP, a FED panel, and so on.

The present application claims priority to Patent Application No. 2009-074034 filed in Japan on Mar. 25, 2009 under the Paris Convention and provisions of national law in a designated State, the entire contents of which are hereby incorporated by reference.

### DESCRIPTION OF REFERENCE NUMERALS

1 protective plate
2 liquid crystal panel
3 support substrate
4 housing
5, 51 to 53 antireflection film
6, 12 circularly polarizing plate
7 infrared ray shielding film
8, 13 polarizer
9, 14 λ/4 phase difference plate
10, 15 linear polarizer
11a, 11b, 16a, 16b protective layer
17 support
20, 23 air layer
21 base layer
30 backlight
60 light guide plate
61 light source
100, 200, 300, 310, 320, 400, 500, 600 display device

1. A display device comprising:
a display panel; and
a protective plate disposed further toward a viewing surface side than the display panel, wherein
a low reflection film formed with a nanostructure is provided on a main surface of the protective plate on the viewing surface side, and
a circularly polarizing plate and an infrared ray shielding film are disposed in sequence from the protective plate side toward the display panel side on a main surface of the protective plate on a side for disposing the display panel.

2. The display device according to claim 1, wherein the display panel includes a light shielding member in a non-display region, and
the infrared ray shielding film is formed in a region corresponding to the light shielding member.

3. The display device according to claim 1,
wherein the infrared ray shielding film contains a metal oxide.

4. The display device according to claim 1, wherein the protective plate and the display panel are thermally separated.

5. The display device according to claim 1, wherein
the protective plate comprises a base layer on which a phase difference in a surface direction and a perpendicular direction is substantially zero, and
the base layer is disposed further toward the display panel side than the infrared ray shielding film.

6. The display device according to claim 1, wherein the circularly polarizing plate is constituted by a linear polarizer and a λ/4 phase difference plate, and attached to the protective plate via a protective layer.

7. The display device according to claim 1, wherein the display device further comprises a support substrate provided on an opposite side to a side of the display panel on which the protective plate is disposed.

8. The display device according to claim 7, wherein the display device further comprises an additional low reflection film formed with a nanostructure between the display panel and the support substrate.

9. The display device according to claim 1 wherein the display device further comprises a light source provided on the opposite side to the side of the display panel on which the protective plate is disposed.

10. The display device according to claim 7, wherein the display panel and the support substrate contact each other.

11. The display device according to claim 7, wherein the support substrate is a light guide plate.

12. The display device according to claim 7, wherein the display device is digital signage.
